(19) United States
(12) Patent Application Publication
(10) Pub. No.: US 2025/0247660 A1
(43) Pub. Date: Jul. 31, 2025

(54) Ambisonic Decoder Filters

(71) Applicant: Sony Interactive Entertainment Inc., Tokyo (JP)

(72) Inventor: Calum Armstrong, London (GB)

(73) Assignee: Sony Interactive Entertainment Inc., Tokyo (JP)

(21) Appl. No.: 19/039,941

(22) Filed: Jan. 29, 2025

(30) Foreign Application Priority Data
Jan. 29, 2024 (GB) 2401110.8

(51) Int. Cl. H04S 5/00; H04S 7/00

(52) U.S. Cl. CPC H04S 5/005; H04S 7/00; H04S 2420/01

(57) ABSTRACT

A computer implemented method of generating an Ambisonic decoder filter for binaural rendering of Ambisonic signals according to a combination of head-related transfer functions (HRTFs), the method comprising: obtaining Ambisonic decoder filters for each of a plurality of HRTF impulse response (IR) sets, each HRTF IR set comprising a plurality of IRs, each IR associated with a different sound source direction; combining each Ambisonic decoder filter with a set of impulses rendered in the Ambisonic domain and associated with different sound source directions to generate a plurality of Ambisonically rendered IR sets; combining at least one of the Ambisonically rendered IR sets with at least one other of the Ambisonically rendered IR sets to generate a combined Ambisonically rendered IR set; and encoding the combined Ambisonically rendered IR set into the Ambisonic domain to generate an Ambisonic decoder filter adapted to binauralise Ambisonic signals according to the combination of HRTFs from which the combined Ambisonically rendered IR set was generated.

### CROSS-REFERENCE TO RELATED APPLICATION

The present application claims priority from United Kingdom Patent Application No. GB 240110.8, filed Jan. 29, 2024, the disclosure of which is hereby incorporated herein by reference.

### FIELD OF THE INVENTION

The present invention relates to the field of 3D audio. In particular, the invention relates to methods and systems for rendering Ambisonic audio signals as spatialised binaural audio.

### BACKGROUND

3D audio refers to an immersive audio experience that simulates a three-dimensional sound environment to enhance the listening experience. While traditional stereo audio provides a flat, two-dimensional sound field, the three-dimensional sound environment provided by 3D audio technology can create the perception of sounds coming from different distances and directions, including above and below the listener.

One way of encoding a sound field in 3D audio applications is using Ambisonics. Ambisonic audio signals include multiple channels of audio to capture a spherical sound field, where each channel corresponds to a spherical harmonic used to represent the sound field. Higher-order Ambisonics use a greater number of channels to capture the sound field with even greater accuracy, with the maximum number of channels in each order Ambisonic equal to (l+1)², where l is the order of the Ambisonic. Once a sound field is encoded in Ambisonic form, it can then be rendered according to the audio output device with which the 3D audio is to be reproduced. For example, an Ambisonic signal may be binauralised for output on headphones or played on a surround speaker system using a multi-speaker Ambisonic render.

In some applications, Ambisonic audio may be rendered for output to headphones by utilizing HRTFs (Head Related Transfer Functions). HRTFs describe the way in which a person hears sound in 3D and can change depending on the position of the sound source. Typically, in order to calculate a received sound, a signal transmitted by the sound source is combined with (e.g. multiplied by, or convolved with) the transfer function.

However, applying HRTFs to binauralise an audio signal in Ambisonic format is challenging since Ambisonics is a lossy format where the accuracy of an encoded sound field is limited by the limited order of the Ambisonic representation. For this reason, known computationally cheap techniques such as Moore-Penrose pseudoinversion do not produce accurate spatialisation when binauralising Ambisonic signals, leading to a poor listener experience. Whilst current optimisation methods of binauralising Ambisonic signals result in a more satisfactory spatialisation, these iterative methods are slow and complex to compute, and it is therefore advantageous to have to perform these methods as few times as possible.

Nevertheless, since HRTFs are individual to each person and depend on factors such as the size of the head and shape of the ear, it is often required that many optimised Ambisonic decoder filters must be computed and stored. In this way, performing iterative methods to generate Ambisonic decoders quickly becomes impractical for large databases of HRTFs.

Accordingly, there exists a need for a solution to mitigate at least some of the problems described above associated with the binaural rendering of Ambisonic audio signals.

### SUMMARY OF INVENTION

In a first aspect the invention provides a computer implemented method of generating an Ambisonic decoder filter for binaural rendering of Ambisonic signals according to a combination of head-related transfer functions (HRTFs), the method comprising: obtaining Ambisonic decoder filters for each of a plurality of HRTF impulse response (IR) sets, each HRTF IR set comprising a plurality of IRs, each IR associated with a different sound source direction; combining each Ambisonic decoder filter with a set of impulses rendered in the Ambisonic domain and associated with different sound source directions to generate a plurality of Ambisonically rendered IR sets; combining at least one of the Ambisonically rendered IR sets with at least one other of the Ambisonically rendered IR sets to generate a combined Ambisonically rendered IR set; and encoding the combined Ambisonically rendered IR set into the Ambisonic domain to generate an Ambisonic decoder filter adapted to binauralise Ambisonic signals according to the combination of HRTFs from which the combined Ambisonically rendered IR set was generated. The result of performing the method according to the first aspect is a newly generated Ambisonic decoder filter that is different to those retrieved in the “obtaining” step of the first aspect. Specifically, the generated Ambisonic decoder filter may binauralise Ambisonic signals according to the combined response of each HRTF to which the obtained Ambisonic decoder filters correspond.

The inventors have found that starting with a plurality of Ambisonic decoder filters, each of the Ambisonic decoder filters corresponding to a HRTF IR set, Ambisonic decoder filters corresponding to the response of any combination of the HRTF IR sets can be generated in a computationally efficient manner by applying the method of the first aspect. In this way, instead of needing to compute and store Ambisonic decoder filters for any possible combination of the HRTF IR sets in question, Ambisonic decoder filters may only need to be stored for each of the individual HRTF IR sets in question, and Ambisonic decoder filters for any combination of those HRTF IR sets may be simply computed when required. Consequently, memory and processing efficiency are improved.

An “Ambisonic decoder filter” according to the present disclosure may be defined as a filter which maps Ambisonic signals of a given order onto a left side/ear signal and/or a right side/ear signal for binaural playback of the Ambisonic signal according to a head related transfer function associated with said Ambisonic decoder filter. Such a mapping may allow binaural playback of Ambisonic signals on headphones. A decoder filter is typically in the form of a matrix that may be applied to an Ambisonic input signal through multiplication or convolution. The Ambisonic decoder filter matrix may have a dimension equal to the number of Ambisonic channels by the number of samples in the time domain. As used throughout this disclosure, “decoding” refers to the general process of converting a signal from the Ambisonic domain to another domain such as the binaural domain, and “encoding” refers to the reverse process of converting a signal from another domain to the Ambisonic domain.

The “HRTF impulse response sets” may comprise a plurality of impulse responses which define, in the time domain, the frequency response of the HRTF at a given sound source direction. Such a sound source direction may be expressed as an angular position comprising pair of angles (θ, ϕ) in a spherical coordinate system where θ is the polar angle and ϕ is the elevation angle. Each set may define the HRTF for either the left ear, the right ear or for both the left and right ears. As described above, a HRTF impulse response set may be associated with a corresponding Ambisonic decoder filter which allows binaural rendering of Ambisonic signals according to the impulse response set. The number of impulse responses at different angular positions in a set corresponding to a HRTF defines the resolution of the HRTF. Typically, a single HRTF IR set may comprise anywhere between a few hundred to a few thousand IRs at different combinations of angles.

The term “combining” according to this disclosure may comprise a convolution or multiplication of the two elements described as being combined. This may be dependent on the domain (time or frequency) in which the two elements being combined are expressed.

The “set of impulses” may be viewed as a dummy input signal such that when combined with an Ambisonic decoder filter, an Ambisonically rendered IR set is generated corresponding to the Ambisonic decoder filter. The set of impulses may be a matrix having a dimension equal to the number of Ambisonic channels by the number of sampled angular positions, typically equal to the number of impulse responses in an impulse response set. The set of impulses may be utilized in its regular matrix or its transposed matrix form.

In some examples, encoding the combined Ambisonically rendered IR set into the Ambisonic domain comprises combining the combined Ambisonically rendered IR set with a matrix stored in a memory component. The memory component may comprise a local storage component and/or external storage. Typically, the matrix stored in the memory component is a Moore-Penrose pseudo-inverse of a re-encoding matrix, said re-encoding matrix having elements comprising spherical harmonic functions evaluated at sound source directions corresponding to the sound source directions in the combined Ambisonically rendered IR set. The inventors have found that unlike when using an encoding method based on a simple matrix multiplication to initially encode a HRTF IR set into the Ambisonic domain, there is no significant reduction in spatialisation quality between Ambisonic decoder filters generated using optimisation methods and Ambisonic decoder filters generated by encoding the combined Ambisonically rendered IR set generated according to the invention using a stored matrix such as a Moore-Penrose pseudo-inverse of a re-encoding matrix. It is therefore not necessary to apply a computationally expensive encoding technique such as the MagLS method to the combined Ambisonically rendered IR set to derive a corresponding Ambisonic decoder filter. If the “obtained” Ambisonic decoder filters provide high quality spatialisation themselves, this is maintained when encoding the combined Ambisonically rendered IR set into the Ambisonic domain. In this way, high quality Ambisonic decoder filters can be generated in a computationally efficient manner.

In some examples, each HRTF IR set is a HRTF associated with a single feature variation, each feature variation corresponding to a variation of a user perceived property of a virtual sound source. A perceived property may be, for example, a perceived virtual position of a sound source, i.e., the position at which the user believes the virtual sound source is coming from. A perceived property may alternatively or additionally relate to a timbre or character of a sound.

Typically, the feature variation is at least one of a height variation, a width variation, and a flavour variation. For example, a set of 10 HRTFs may encode 10 different height variations, a set of 10 HRTFs may encode 10 different width variations, and a set of 10 HRTFs may encode 10 different flavour variations.

It has been found by the inventors that HRTFs can be generated which encode a particular variation of an independent feature. Each feature variation may correspond to a modification of one or more properties that define the response of a HRTF. Examples of such properties are an interaural time delay, an interaural level difference, and a first pinna notch.

Since the interaural time delay and the interaural level difference are associated with the perceived lateralisation a sound source, variation of these parameters may control width variations which move the perceived virtual location of a sound source in the horizontal plane.

The first pinna notch is associated with the perceived height of a sound source. Variation of this parameter may control height variations which move the perceived virtual location along the vertical axis.

Parameters affecting a perception of a sound source are not limited to those mentioned above and may additionally comprise other parameters, for example, a second pinnae notch or timbre. Any combination or variation of the parameters mentioned herein or otherwise may correspond to a different flavour variation.

A HRTF IR set which encodes a single feature variation may be referred to as a partial or component HRTF since combining a plurality of said partial/component HRTFs, for example by means of a convolution, generates a new HRTF which encodes the feature variations of each of the combined partial/component HRTFs. Using the example above where three different sets of features and 10 variations of each feature are provided, 1000 different HRTFs may be generated from the 30 partial/component HRTFs through combinations of different feature variations.

By applying the method of the first aspect according to examples where the impulse response set wherein each HRTF IR set is a HRTF associated with a single feature variation (i.e. a partial/component HRTF), Ambisonic decoder filters which correspond to combinations of feature variations can be generated in a computationally efficient manner whilst offering a high quality spatialisation. In this way, instead of needing to compute and store Ambisonic decoder filters for every combination of feature variations, Ambisonic decoder filters for any combination of feature variations may be simply computed when required. Consequently, memory and processing efficiency are improved.

In some examples, each sound source direction comprises a polar angle and an elevation angle in a spherical coordinate system. Typically, the set of impulses rendered in the Ambisonic domain comprises Dirac delta functions encoded into Ambisonics at a plurality of different polar and elevation angles. In this way, the response of each of the Ambisonic decoder filters to impulses originating from a plurality of different angles can be characterized, and the resulting plurality of Ambisonically rendered IR sets can be combined according to the desired combination of HRTFs to which the Ambisonic decoder filters correspond.

Typically, the obtaining Ambisonic decoder filters for each of a plurality of HRTF IR sets comprises obtaining, from a memory component, Ambisonic decoder filters for each of the plurality of HRTF IR sets. Typically, the Ambisonic decoder filters are pre-computed using known techniques for solving the Ambisonic decoding equation such as the optimisation methods described above. By having the Ambisonic decoder filters for each of the plurality of IR sets stored in a memory component, these can be easily accessed without requiring their computation in real time. The memory component may comprise a local storage component and/or external storage.

In some applications, the memory component may only store Ambisonic decoder filters configured to decode Ambisonic signals to one of the two binaural audio channels. In these applications, the obtaining Ambisonic decoder filters for each of a plurality of HRTF IR sets preferably comprises obtaining, from a memory component, a first set of Ambisonic decoder filters adapted to decode Ambisonic signals for a first binaural audio channel; copying the first set of Ambisonic decoder filters to generate a second set of Ambisonic decoder filters; and modifying the second set of Ambisonic decoder filters such that they are adapted to decode Ambisonic signals for a second binaural audio channel. The “modifying” of the second set of Ambisonic decoder filters may be understood as performing one or more operations on the first set of Ambisonic decoder filters to create a second set of Ambisonic decoder filters that mirror the mapping of the first set of Ambisonic decoder filters but for the other binaural audio channel. This is possible due to the assumed symmetry of the head. For example, the left ear mapping of a sound source at an angular position (θ, ϕ)=(330°, 0°) may be approximately the same as a right ear mapping at an angular position (θ, ϕ)=(30°, 0°). The “modifying” may include, for each Ambisonic decoder filter, multiplying a set of the Ambisonic channels by −1, wherein the set of the Ambisonic channels are those having opposite horizontal components with respect to the spherical harmonic patterns that they represent. By utilizing this symmetry, memory usage can be reduced as it is only necessary to store Ambisonic decoder filters which can decode Ambisonic signals to one of the two binaural channels.

Alternatively, the symmetry of the head may also be utilized by modifying the generated Ambisonic decoder filters rather than those obtained from the memory component, allowing for convenient and memory efficient binaural playback of Ambisonic audio signals. A generated Ambisonic decoder filter which is suitable to be applied to a first audio channel, e.g. a left ear signal, may be copied and the copy modified such that the modified copy is suitable to be applied to a second audio channel, e.g. a right ear signal.

In this way, in some examples, the obtaining Ambisonic decoder filters for each of a plurality of HRTF IR sets comprises: obtaining, from a memory component, a first set of Ambisonic decoder filters adapted to decode Ambisonic signals for a first binaural audio channel; and the method further comprises: copying the generated Ambisonic decoder filter adapted to binauralise Ambisonic signals according to the combination of HRTFs from which the combined Ambisonically rendered IR set was generated to generate a copy of the generated Ambisonic decoder filter, and modifying the copy of the generated Ambisonic decoder filter such that it is adapted to decode Ambisonic signals for a second binaural audio channel. In a similar manner as described above, the “modifying” may be understood as performing one or more operations on the generated Ambisonic decoder filter to create a modified copy of the generated Ambisonic decoder filter that mirrors the mapping of the generated Ambisonic decoder filters but for the other binaural audio channel. As above, the “modifying” may include, multiplying a set of the Ambisonic channels in the generated Ambisonic decoder filter by −1, wherein the set of the Ambisonic channels are those having opposite horizontal components with respect to the spherical harmonic patterns that they represent.

In some examples, prior to obtaining Ambisonic decoder filters for each of a plurality of HRTF IR sets, the method comprises: obtaining, from a memory component, a plurality of HRTF IR sets; generating Ambisonic decoder filters for each of the plurality of IR sets; and storing the generated Ambisonic decoder filters in the memory component. The generating Ambisonic decoder filters in these examples may be performed using an optimisation method in order to maximise the spatialisation quality. Such an optimisation method may include minimising a function modelling a perceived dissimilarity between an output signal and a target signal, and/or performing minimisation based on least-squares. An example of such an optimisation method for solving the Ambisonic decoding equation is the magnitude least squares (MagLS) method. However, modifications of this method or other conventional methods of solving the Ambisonic decoding equation may also be applied. In this way, Ambisonic decoder filters corresponding to the stored HRTFs can be computed in an optimal manner to provide a high quality spatialisation, therefore ensuring the method according to the first aspect generates a high quality Ambisonic decoder filter.

In some examples, the obtained Ambisonic decoder filters were pre-generated using an optimisation method. Said optimisation method may be the same or similar to those methods described above. Pre-generating and storing the Ambisonic decoder filters according to the stored HRTFs ensures a high-quality specialisation, which is then propagated through when generating the Ambisonic decoder filter according to the combination of the Ambisonically rendered HRTFs.

Preferably the Ambisonic decoder filters are configured to decode 5th order Ambisonic signals. 5th order Ambisonics provides a good level of trade-off between spatialisation quality and computational efficiency. However, the Ambisonic decoder filters may be configured to decode other orders of Ambisonic signals.

Typically, the result of the encoding the combined Ambisonically rendered IR set into the Ambisonic domain is transformed into the frequency domain. This may be performed, for example, by applying a Fourier transform. This may be computed using algorithms which calculate a discreet Fourier transform such as the fast Fourier transform algorithm (FFT). In this way, the generated Ambisonic decoder filter can be applied to an Ambisonic signal provided in the frequency domain.

In accordance with a second aspect of the invention, there is provided a method of rendering an Ambisonic audio signal for binaural playback, the method comprising: generating an Ambisonic decoder filter according to the first aspect; and applying the Ambisonic decoder filter to an Ambisonic audio signal.

In this way, an Ambisonic signal can be efficiently rendered for binaural playback by applying an Ambisonic decoder filter generated according to the method of the first aspect. Therefore, the advantages described above in relation to the first aspect equally apply to the second aspect. The resulting binaural audio may be played back on an audio output device such as headphones.

In some examples, the Ambisonic audio signal comprises a video game sound effect. Preferably, when the sound comprises a video game sound effect, the method of the second aspect is a method of rendering an Ambisonic audio signal in a video gaming system for binaural playback.

In some examples, the Ambisonic audio signal comprises an ambient sound effect. Ambient sound effects refer to sounds such as wind, footsteps, rain, waves and other sounds which may be considered background noise, rather than other sounds such as dialogue. Ambient sound effects may be considered sound effects associated with the scenery of the virtual environment, or background noise of a virtual environment. The ambient sound effect may an ambient sound effect in a video game.

In accordance with a third aspect, there is provided a system for generating an Ambisonic decoder filter for binaural rendering of Ambisonic signals according to a combination of head-related transfer functions (HRTFs), the system comprising: an obtaining unit configured to obtain Ambisonic decoder filters for each of a plurality of HRTF impulse response (IR) sets, each HRTF IR set comprising a plurality of IRs, each IR associated with a different sound source direction; a first combining unit configured to combine each Ambisonic decoder filter with a set of impulses rendered in the Ambisonic domain and associated with different sound source directions to generate a plurality of Ambisonically rendered IR sets; a second combining unit configured to combine at least one of the Ambisonically rendered IR sets with at least one other of the Ambisonically rendered IR sets to generate a combined Ambisonically rendered IR set; and an encoding unit configured to encode the combined Ambisonically rendered IR set into the Ambisonic domain to generate an Ambisonic decoder filter adapted to binauralise Ambisonic signals according to the combination of HRTFs from which the combined Ambisonically rendered IR set was generated.

The system according to the third aspect may be a video gaming system and the obtaining unit, first combining unit, second combining unit and encoding unit may be part of one or more processors of the system. The system may also be communicatively coupled to one or more local or remote memory components. The first combining unit and second combining unit may refer to the same or different combining units.

In accordance with a fourth aspect, there is provided a computer program comprising computer-readable instructions which, when executed by one or more processors, cause the one or more processors to perform a method according to the first aspect or the second aspect.

In accordance with a fifth aspect, there is provided a non-transitory storage medium storing computer-readable instructions which, when executed by one or more processors, cause the one or more processors to perform a method according to the first aspect or the second aspect.

It will be appreciated that elements of the first aspect apply to all other aspects, along with their associated advantages.

### BRIEF DESCRIPTION OF DRAWINGS

Embodiments of the invention are described below, by way of example only, with reference to the accompanying drawings, in which:

FIG. 1 schematically illustrates Ambisonic Channel Numbers corresponding to the spherical harmonics up to the fifth order Ambisonics;

FIG. 2 is a flow chart of an example of a method in accordance with an embodiment of the invention;

FIG. 3 is a further flow chart of an example of a method in accordance with an embodiment of the invention;

FIG. 4 is a further flow chart of an example of a method in accordance with an embodiment of the invention; and

FIG. 5 is a further flow chart of an example of a method in accordance with an embodiment of the invention.

### DETAILED DESCRIPTION

Ambisonic audio signals include multiple channels of audio to capture a spherical sound field, where each channel corresponds to a spherical harmonic used to represent the sound field. Higher-order Ambisonics use a greater number of channels to capture the sound field with even greater accuracy, though these higher orders also require greater storage and processing requirements. The maximum number of channels in a given order Ambisonic is equal to (l+1)², where l is the order of the Ambisonic, with higher order Ambisonics including all channels of lower order Ambisonics.

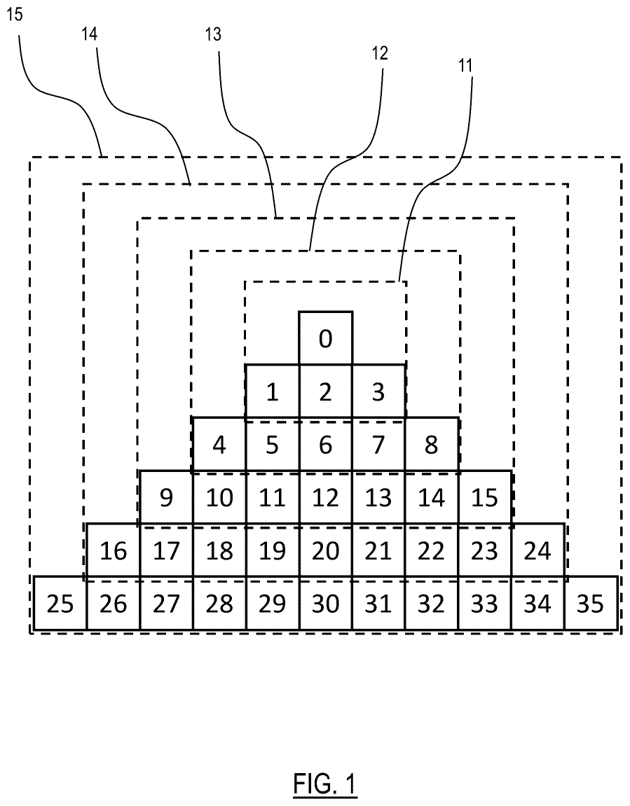

FIG. 1 schematically illustrates the channels of the first to fifth order Ambisonics using the Ambisonic Channel Numbers (ACN) component ordering format, with channels shown as solid boxes and orders of Ambisonics grouping these channels within dashed boxes. The first order Ambisonic 11 includes channels 0 to 3, the second order Ambisonic 12 includes channels 0 to 8, the third order Ambisonic 13 includes channels 0 to 15, the fourth order Ambisonic 14 includes channels 0 to 24, and the fifth order Ambisonic 15 includes channels 0 to 35.

To playback Ambisonic audio signals, the signals first must be decoded or rendered for the intended audio output device configuration. Such decoding of Ambisonic signals may be performed by Ambisonic decoder filters which take, as an input, a signal in Ambisonic format, and spatially render that signal according to the audio output device of a user such that the result is a spatial audio signal reproducible by said audio output device.

For audio output devices that can reproduce binaural audio such as headphones, Head related transfer functions (HRTFs) are often applied to audio such that when heard by a user, the audio is perceived to replicate the intended spatialisation (i.e. a sound originating from a virtual location is perceived by the user to be originating from a location as close as possible to said virtual location). Therefore, when rendering an audio signal in an Ambisonic format, the sound should be rendered according to the spatialisation governed by a HRTF.

However, as is described in the background section above, HRTFs are individual to each person and depend heavily on factors such as the size of the head and shape of the ear. Consequently, to ensure that each user is provided with a suitable HRTF which results in an accurate spatialisation, a large bank of HRTFs is often required to be stored to cover a wide range of variations.

To provide a suitable level of customization, a bank of different HRTFs can be stored that encode different combinations of height variations, width variations, and flavour (timbre) variations. Each feature variation may correspond to a modification of one or more properties that define the response of a HRTF. Examples of such properties are an interaural time delay, an interaural level difference, and a first pinna notch.

The resulting feature variations provide variations in the perceived virtual location of a sound in the vertical axis, the perceived virtual location of a sound in the horizontal axis, and the timbre or character of a sound respectively. An example HRTF may encode a first height variation, a fifth width variation and a third feature variation out of a set of height, width, and feature variations. A user can then select a HRTF which encodes the set of feature variations which provide the most accurate spatialisation for their ear and head shape.

Furthermore, a similarly large bank of Ambisonic decoder filters is therefore also required to be stored to cover the same feature variations as encoded by all stored HRTFs.

However, to save memory, it has been found by the inventors that certain HRTFs, sometimes referred to as partial or component HRTFs, can be generated to encode a particular variation of a single independent feature. Two or more of these partial HRTFs can then be combined, generally by way of a convolution at runtime, to generate a single HRTF which encodes each feature variation present in the combined partial HRTFs. For example, a first partial HRTF may encode a first height variation only, a second partial HRTF may encode a fifth width variation only, and a third partial HRTF may encode a third flavour variation only. These may be combined to generate a single HRTF which encodes the first height variation, the fifth width variation and the third feature variation.

When there are multiple independent features and multiple variations of each feature to be encoded, memory usage can be reduced by storing only the partial HRTFs and combining them into any required combination at runtime. For example, with 3 independent features and 10 different variations of each feature, 30 partial HRTFs can be stored to generate any one of 1000 possible combinations of feature variations at runtime.

To further reduce memory usage, it was initially proposed that a similar technique to storing and combining partial HRTFs could also be applied to Ambisonic decoder filters, (i.e., a bank of partial Ambisonic decoder filters corresponding to the partial HRTFs could be stored and combined at runtime to generate Ambisonic decoder filters which render Ambisonic signals according to the combinations of feature variations). However, it was found by the inventors that the methodology for combining HRTFs does not directly translate over to combining Ambisonic decoder filters, and the later requires a more complex process. Examples of such a process are described as embodiments of the invention herein, thus allowing a further reduction in memory usage.

Embodiments of the invention are configured to generate an Ambisonic decoder filter which converts an input signal in Ambisonic format into a binaural audio signal for rendering on an audio output device such as headphones according to a combination of head-related transfer functions (HRTFs). In this way, in a similar manner to the partial HRTFs described above, a base set of Ambisonic decoder filters encoding independent feature variations can be stored in memory, and these can be combined at runtime to generate Ambisonic decoder filters which render Ambisonic audio signals according to combinations of feature variations encoded in the base set.

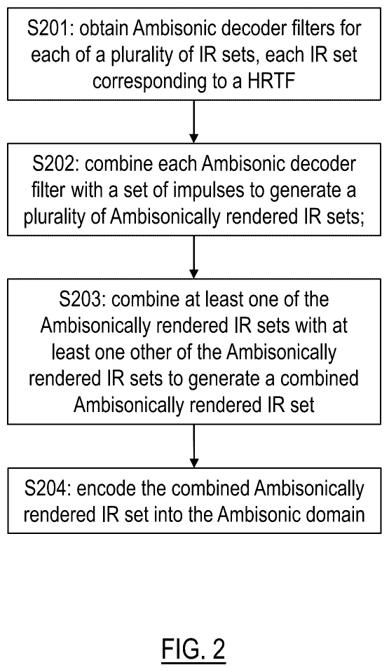

FIG. 2 is a flow chart showing the steps of an example of a method in accordance with an embodiment of the invention for generating Ambisonic decoder filters. Typically, said Ambisonic decoder filters are suitable for binauralising 5th order Ambisonic signals.

In step S201, Ambisonic decoder filters for each of a plurality of IR sets are obtained, wherein each IR set corresponds to a HRTF. The Ambisonic decoder filters may be obtained from a memory component such as a local storage component or remotely from external storage. A number of Ambisonic decoder filters may be pre-computed from a set of stored HRTFs and stored on the memory component, typically by applying an optimisation method such as the known magnitude least squares (MagLS) method for generating Ambisonic decoder filters. As described above, each HRTF in the stored HRTF set comprises a plurality of IRs, each IR associated with a different sound source direction typically defined by a polar angle and an elevation angle in a spherical coordinate system.

The obtained Ambisonic decoder filters may have been pre-computed from a set of stored partial/component HRTFs which are each associated with a single feature variation, each feature variation corresponding to a variation of a user perceived property of a virtual sound source. Said features and variations thereof may include height (elevation) variations, width (lateral) variations and flavour variations. Each partial HRTF may exhibit the sound modification characteristics of a variation of one of the features described above. Therefore, each Ambisonic decoder filter associated with each partial HRTF is adapted to decode Ambisonic signals according to feature variation with which the partial/component HRTF is associated.

To save memory, in some embodiments, the stored form of the Ambisonic decoder filters may be filters that are adapted to decode Ambisonic signals for a first binaural audio channel such as a left ear or a right ear channel. Using the assumed symmetry of the head, the obtaining process of S201 may involve copying a first set of Ambisonic decoder filters obtained from the memory component to generate a second set of Ambisonic decoder filters, and then modifying the second set of Ambisonic decoder filters such that they are adapted to decode Ambisonic signals for a second binaural audio channel. The modifying of the second set of Ambisonic decoder filters may include applying a transformation to each element such that equivalent decoding is performed for the second binaural audio channel as the first binaural audio channel.

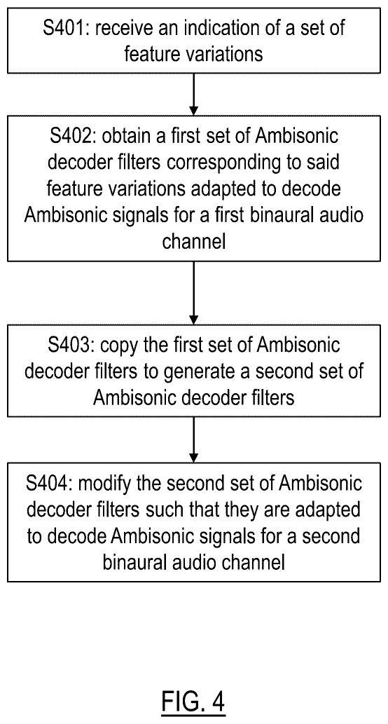

FIG. 4 provides an exemplary process for obtaining Ambisonic decoder filters for both binaural audio channels which correspond to a set of feature variations.

At step S401, an indication of a set of feature variations is received. In applications where the method is applied to a video gaming system, this may involve, for example, a user selecting a set of feature variations, or a process in which feature variations are automatically selected for a user by the video gaming system based on feedback provided to the video gaming system by the user. An example of this process is described in further detail in United Kingdom patent application number 2218264.6.

At step S402, a first set of Ambisonic decoder filters corresponding to said feature variations indicated in S401 is obtained. The first set of Ambisonic decoder filters are typically adapted to decode Ambisonic signals for a first binaural audio channel.

At step S403, the first set of Ambisonic decoder filters are copied to generate a second set of Ambisonic decoder filters.

At step S404, the second set of Ambisonic decoder filters are modified such that they are adapted to decode Ambisonic signals for a second binaural audio channel.

Consequently, applying the method described in FIG. 4 allows Ambisonic decoder filters corresponding to each indicated feature variation to be obtained according to step S201 and processed according to the remaining steps of the method.

Alternatively, in some embodiments where the stored form of the Ambisonic decoder filters are filters that are adapted to decode Ambisonic signals for a first binaural audio channel such as a left ear or a right ear channel, the resulting Ambisonic decoder filter generated as a result of step S204 described below may be copied to generate a copy of the generated Ambisonic decoder filter, and the copy modified such that it is adapted to decode Ambisonic signals for a second binaural audio channel.

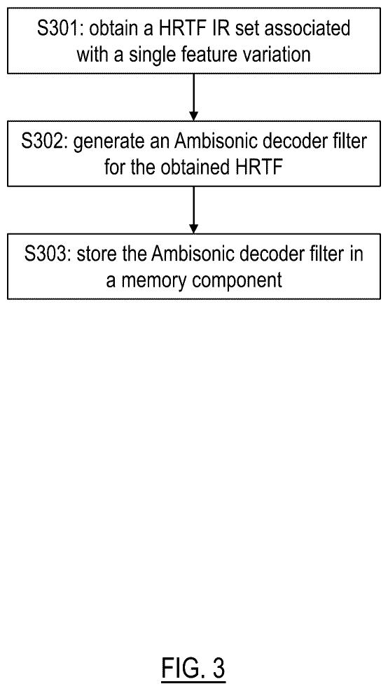

In some embodiments, step S201 may further include generating Ambisonic decoder filters corresponding to a number of stored HRTF IR sets. FIG. 3 provides an exemplary process of generating Ambisonic decoder filters for “obtaining” Ambisonic decoder filters according to step S201, wherein a set of stored HRTF IR sets are partial HRTFs which correspond to single feature variations as described above.

At step S301, a HRTF IR set associated with a single feature variation is obtained, typically from the memory component described above.

At step S302, an Ambisonic decoder filter is generated for the HRTF IR set. Typically, this is performed by applying a known technique for solving the Ambisonic decoding equation such as an optimisation method (e.g. the MagLS method or a variant thereof).

At step S303, the generated Ambisonic decoder filter is stored in the memory component. This method may be repeated to store Ambisonic decoder filters for a bank of HRTF IR sets.

In this way, Ambisonic decoder filters may be obtained according to step S201 and processed according to the remaining steps of the method.

Once the Ambisonic decoder filters are obtained according to step S201, at step S202, the obtained Ambisonic decoder filters are each combined (convolved or multiplied) with a set of impulses to generate a plurality of Ambisonically rendered IR sets. The set of impulses typically is a set of impulses rendered in the Ambisonic domain and is usually made up of Dirac delta functions encoded into Ambisonics at a plurality of different sound source directions which are typically pairs of polar and elevation angles in a spherical coordinate system. By probing the response of each of the Ambisonic decoder filters using impulses from different angles, impulse responses at those angles are generated, and the resulting sets of impulse responses correspond Ambisonically rendered IR sets.

At step S203, at least one of the Ambisonically rendered IR sets is combined (convolved or multiplied) with at least one other of the Ambisonically rendered IR sets to generate a combined Ambisonically rendered IR set. In particular, the resulting combined Ambisonically rendered IR set is a new IR set which codes the combined responses of each of the individual Ambisonically rendered IR sets used to generate it.

At step S204, the combined Ambisonically rendered IR set is encoded back into the Ambisonic domain. Such encoding may be performed by combining (multiplying or convolving) the combined Ambisonically rendered IR set with a Moore-Penrose pseudo-inverse of the set of impulses a re-encoding matrix, said re-encoding matrix having elements comprising spherical harmonic functions evaluated at sound source directions corresponding to the sound source directions in the combined Ambisonically rendered IR set. The result is an Ambisonic decoder filter which is adapted to render Ambisonic signals according to the combined response of the Ambisonic decoder filters used to generate it.

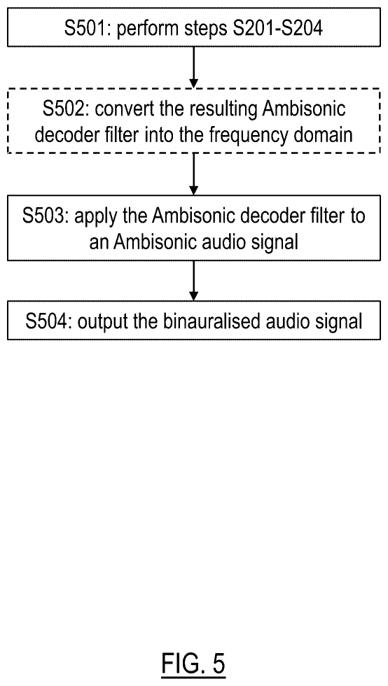

FIG. 5 provides an exemplary process for using an Ambisonic decoder filter generated in accordance with the process illustrated in FIG. 2 to decode an Ambisonic audio signal. Such a process may be performed by a video gaming system. In applications where the method is applied to a video gaming system, such Ambisonic audio signals may be video game sound effects, or more specifically ambient sound effects in a video game. In some embodiments, the generated Ambisonic decoder filter is configured to binauralise a 5th order Ambisonic signal. However, in other embodiments, the Ambisonic decoder filter may be configured to binauralise other orders of Ambisonic audio signals.

After performing the process illustrated in FIG. 2 at step S501 to generate an Ambisonic decoder filter, the Ambisonic decoder filter may optionally be converted into the frequency domain at step S502. This may be performed by applying a Fourier transform algorithm to the generated Ambisonic decoder filter.

At step S503, the Ambisonic decoder filter is then applied to an Ambisonic audio signal to render said Ambisonic signal in the binaural domain. Applying the Ambisonic decoder filter to render the Ambisonic audio signal may include convolving each channel of the Ambisonic decoder filter with the corresponding channel of the Ambisonic audio signal and summing the results of the convolutions.

In some embodiments, for example where the Ambisonic decoder filter generated in step S501 is suitable for generating an audio signal for a first audio channel (e.g. a left ear channel) in the binaural domain, steps S502 and S503 may be performed a second time but applied to a second Ambisonic decoder filter suitable for generating an audio signal for a second audio channel (e.g. a right eat channel) in the binaural domain. Such a second Ambisonic decoder filter may, in some embodiments, be generated by copying the Ambisonic decoder filter generated in step S501 and the modifying the copy of the Ambisonic decoder filter generated in step S501 according to the methods described herein such that the modified copy is suitable to be applied to the second audio channel. At step S504, the binauralised Ambisonic audio signal is then output to an audio output device such as a pair of headphones which can reproduce the spatialized audio for a user.

Having described aspects of the disclosure in detail, it will be apparent that modifications and variations are possible without departing from the scope of aspects of the disclosure as defined in the appended claims. As various changes could be made in the above methods and products without departing from the scope of aspects of the disclosure, it is intended that all matter contained in the above description and shown in the accompanying drawings shall be interpreted as illustrative and not in a limiting sense.

1. A computer implemented method of generating an Ambisonic decoder filter for binaural rendering of Ambisonic signals according to a combination of head-related transfer functions (HRTFs), the method comprising:
obtaining Ambisonic decoder filters for each of a plurality of HRTF impulse response (IR) sets, each HRTF IR set comprising a plurality of IRs, each IR associated with a different sound source direction;
combining each Ambisonic decoder filter with a set of impulses rendered in the Ambisonic domain and associated with different sound source directions to generate a plurality of Ambisonically rendered IR sets;
combining at least one of the Ambisonically rendered IR sets with at least one other of the Ambisonically rendered IR sets to generate a combined Ambisonically rendered IR set; and
encoding the combined Ambisonically rendered IR set into the Ambisonic domain to generate an Ambisonic decoder filter adapted to binauralise Ambisonic signals according to the combination of HRTFs from which the combined Ambisonically rendered IR set was generated.

2. The method of claim 1, wherein encoding the combined Ambisonically rendered IR set into the Ambisonic domain comprises combining the combined Ambisonically rendered IR set with a matrix stored in a memory component.

3. The method of claim 2, wherein the matrix stored in the memory component comprises a Moore-Penrose pseudo-inverse of a re-encoding matrix, said re-encoding matrix having elements comprising spherical harmonic functions evaluated at sound source directions corresponding to the sound source directions in the combined Ambisonically rendered IR set.

4. The method of claim 1, wherein each HRTF IR set is a HRTF associated with a single feature variation, each feature variation corresponding to a variation of a user perceived property of a virtual sound source.

5. The method of claim 1, wherein the feature variation is at least one of a height variation, a width variation, and a flavour variation.

6. The method of claim 1, wherein each sound source direction comprises a polar angle and an elevation angle in a spherical coordinate system.

7. The method of claim 6, wherein the set of impulses rendered in the Ambisonic domain comprises Dirac delta functions encoded into Ambisonics at a plurality of different polar and elevation angles.

8. The method of claim 1, wherein the obtaining Ambisonic decoder filters for each of a plurality of HRTF IR sets comprises obtaining, from a memory component, Ambisonic decoder filters for each of the plurality of HRTF IR sets.

9. The method of claim 1, wherein the obtaining Ambisonic decoder filters for each of a plurality of HRTF IR sets comprises:
obtaining, from a memory component, a first set of Ambisonic decoder filters adapted to decode Ambisonic signals for a first binaural audio channel;
copying the first set of Ambisonic decoder filters to generate a second set of Ambisonic decoder filters; and
modifying the second set of Ambisonic decoder filters such that they are adapted to decode Ambisonic signals for a second binaural audio channel.

10. The method of claim 1, wherein the obtaining Ambisonic decoder filters for each of a plurality of HRTF IR sets comprises:
obtaining, from a memory component, a first set of Ambisonic decoder filters adapted to decode Ambisonic signals for a first binaural audio channel; and wherein the method further comprises:
copying the generated Ambisonic decoder filter adapted to binauralise Ambisonic signals according to the combination of HRTFs from which the combined Ambisonically rendered IR set was generated to generate a copy of the generated Ambisonic decoder filter, and modifying the copy of the generated Ambisonic decoder filter such that it is adapted to decode Ambisonic signals for a second binaural audio channel.

11. The method of claim 1, wherein prior to obtaining Ambisonic decoder filters for each of a plurality of HRTF IR sets, the method comprises:
obtaining, from a memory component, a plurality of HRTF IR sets;
generating Ambisonic decoder filters for each of the plurality of IR sets; and
storing the generated Ambisonic decoder filters in the memory component.

12. The method of claim 1, wherein the obtained Ambisonic decoder filters were pre-generated using an optimisation method.

13. The method of claim 1, wherein the Ambisonic decoder filters are configured to decode 5th order Ambisonic signals.

14. The method of claim 1, further comprising transforming, into the frequency domain, the result of the encoding the combined Ambisonically rendered IR set into the Ambisonic domain.

15. A method of rendering an Ambisonic audio signal for binaural playback, the method comprising:
generating an Ambisonic decoder filter according to the method of claim 1; and
applying the Ambisonic decoder filter to an Ambisonic audio signal.

16. The method of claim 15, wherein the Ambisonic audio signal comprises a video game sound effect.

17. The method of claim 15, wherein the Ambisonic audio signal comprises an ambient sound effect.

18. A system for generating an Ambisonic decoder filter for binaural rendering of Ambisonic signals according to a combination of head-related transfer functions (HRTFs), the system comprising:
an obtaining unit configured to obtain Ambisonic decoder filters for each of a plurality of HRTF impulse response (IR) sets, each HRTF IR set comprising a plurality of IRs, each IR associated with a different sound source direction;
a first combining unit configured to combine each Ambisonic decoder filter with a set of impulses rendered in the Ambisonic domain and associated with different sound source directions to generate a plurality of Ambisonically rendered IR sets;
a second combining unit configured to combine at least one of the Ambisonically rendered IR sets with at least one other of the Ambisonically rendered IR sets to generate a combined Ambisonically rendered IR set; and
an encoding unit configured to encode the combined Ambisonically rendered IR set into the Ambisonic domain to generate an Ambisonic decoder filter adapted to binauralise Ambisonic signals according to the combination of HRTFs from which the combined Ambisonically rendered IR set was generated.

19. The system of claim 18, wherein the system is a video gaming system.
